(19) United States
(12) Patent Application Publication
(10) Pub. No.: US 2023/0123736 A1
(43) Pub. Date: Apr. 20, 2023

(54) DATA TRANSLATION AND INTEROPERABILITY

(71) Applicant: RedZone Robotics, Inc., Warrendale, PA (US)

(72) Inventors: Tim Renton, Auckland (NZ); Foster J Salotti, Pittsburgh, PA (US); Jason Mizgorski, Pittsburgh, PA (US); Anthony van Iersel, Auckland (NZ); Cody Steliga, Pittsburgh, PA (US); Bill Derkson, Pittburgh, PA (US); Lynn Palmieri, Pittsburgh, PA (US); Dimitrije Balanovic, Auckland (NZ)

(73) Assignee: RedZone Robotics, Inc., Warrendale, PA (US)

(21) Appl. No.: 17/965,743

(22) Filed: Oct. 13, 2022

Related U.S. Application Data
(60) Provisional application No. 63/255,942, filed on Oct. 14, 2021.

(51) Int. Cl. G06F 16/11

(52) U.S. Cl. CPC G06F 16/116

(57) ABSTRACT

In one example, a method includes combining multi-sensor inspection (MIS) data from sensors of inspection platform(s); using respective metadata to select one or more tools for translating the MSI data into a common file format; applying the one or more tools to the first and second MSI data to obtain respective common data formatted files; and providing, via a cloud computing device, access to the common data formatted files. Other implementations may be described and claimed.

### CROSS-REFERENCE TO RELATED APPLICATIONS

This application claims priority to U.S. provisional patent application Ser. No. 63/255,942, filed 14 Oct. 2021, having the title “INFRASTRUCTURE INSPECTION DATA TRANSLATION AND INTEROPERABILITY,” the entire contents of which are incorporated by reference herein.

### BACKGROUND

Infrastructure such as manholes, pipe segments or other vertical shafts need to be inspected and maintained. Visual inspections are often done as a matter of routine upkeep or in response to a noticed issue.

Various systems and methods exist to gather inspection data. For example, inspection data may be obtained by using closed circuit television (CCTV) cameras, sensors that collect visual images, laser, or sonar scanning. Such methods include traversing through a conduit such as a manhole or other underground infrastructure asset with a transportation platform and obtaining inspection data via differing payloads regarding the interior, e.g., images and/or other sensor data for visualizing pipe features such as pipe defects, cracks, intrusions, etc. An inspection crew is deployed to a location and individual pipe segments are inspected, often in a serial fashion, to collect inspection data and analyze it.

### BRIEF SUMMARY

In summary, an embodiment provides a method, comprising: obtaining, in a first data format, first multi-sensor inspection (MIS) data from a first sensor of one or more inspection platforms; obtaining, in a second data format, second MSI data from a second sensor of the one or more inspection platforms; identifying, using a processor, respective metadata associated with the first MSI data and the second MSI data; using the respective metadata to select one or more tools for translating the first and second MSI data into a common file format; the common file format comprising: payload of a respective sensor derived from one or more of the first data format and the second data format; and dictionary metadata comprising at least a part of the respective metadata associated with one or more of the first MSI data and the second MSI data; applying the one or more tools to the first and second MSI data to obtain respective common data formatted files; and providing, via a cloud computing device, access to the common data formatted files.

Another embodiment provides a device, comprising: one or more processors; and a non-transitory storage device operatively coupled to the one or more processors and comprising executable code, the executable code comprising: code that obtains, in a first data format, first multi-sensor inspection (MIS) data from a first sensor of one or more inspection platforms; code that obtains, in a second data format, second MSI data from a second sensor of the one or more inspection platforms; code that identifies respective metadata associated with the first MSI data and the second MSI data; code that uses the respective metadata to select one or more tools for translating the first and second MSI data into a common file format; the common file format comprising: payload of a respective sensor derived from one or more of the first data format and the second data format; and dictionary metadata comprising at least a part of the respective metadata associated with one or more of the first MSI data and the second MSI data; code that applies the one or more tools to the first and second MSI data to obtain respective common data formatted files; and code that provides, via a cloud computing device, access to the common data formatted files.

A computer program product, comprising: a non-transitory storage medium that comprises code that when executed by a processor: obtains, in a first data format, first multi-sensor inspection (MIS) data from a first sensor of one or more inspection platforms; obtains, in a second data format, second MSI data from a second sensor of the one or more inspection platforms; identifies respective metadata associated with the first MSI data and the second MSI data; uses the respective metadata to select one or more tools for translating the first and second MSI data into a common file format; the common file format comprising: payload of a respective sensor derived from one or more of the first data format and the second data format; and dictionary metadata comprising at least a part of the respective metadata associated with one or more of the first MSI data and the second MSI data; applies the one or more tools to the first and second MSI data to obtain respective common data formatted files; and provides, via a cloud computing device, access to the common data formatted files.

The foregoing is a summary and is not intended to be in any way limiting. For a better understanding of the example embodiments, reference can be made to the detailed description and the drawings. The scope of the invention is defined by the claims.

### BRIEF DESCRIPTION OF THE SEVERAL VIEWS OF THE DRAWINGS

FIG. 1 illustrates an example system architecture.

FIG. 2 illustrates example MSI data sources and formats.

FIG. 3 illustrates an example method.

FIG. 4 illustrates an example state progression for MSI data handling tasks.

FIG. 5 illustrates an example hierarchy of objects for processing MSI data according to a workflow.

FIG. 6 illustrates an example of MSI data fusion output.

FIG. 7 illustrates an example system.

### DETAILED DESCRIPTION

It will be readily understood that the components of the embodiments, as generally described and illustrated in the figures herein, may be arranged and designed in a wide variety of ways in addition to the examples described herein. The detailed description uses examples, represented in the figures, but these examples are not intended to limit the scope of the claims.

Reference throughout this specification to “embodiment(s)” (or the like) means that a particular described feature or characteristic is included in that example. The particular feature or characteristic may or may not be claimed. The particular feature may or may not be relevant to other embodiments. For the purpose of this detailed description, each example might be separable from or combined with another example.

Therefore, the described features or characteristics of the examples generally may be combined in any suitable manner, although this is not required. In the detailed description, numerous specific details are provided to give a thorough understanding of example embodiments. One skilled in the relevant art will recognize, however, that the claims can be practiced without one or more of the specific details found in the detailed description, or the claims can be practiced with other methods, components, etc. In other instances, well-known details are not shown or described to avoid obfuscation.

An embodiment provides the ability to absorb all data types and process the information without the need to run through similar parallel near identical processing tools, by ingesting the information at the top of the funnel and packaging it in such a way as the analysis tool can produce required information regardless of the variable data sets brought into the system.

Historically the infrastructure data produced from the technologies used have been processed using the software packages designed for the particular unit, and the analysis workflow designed in such a way that only the outputs from the unit can be processed using the software linked or provided with the equipment. To date the only agnostic software has been CCTV loggers based off a standard video format, however recent developments in proprietary virtual pan tilt zoom tools have seen some providers moving away from the agnostic approach and require equipment to be coded in proprietary tools.

With an embodiment the analysis technology will not have to worry where or from what robot or sensor the information has come from, for example visual defect reporting will all be done in the same tool no matter what equipment the data was recorded with. The transposition of the data to a common file format that can be read by the tools will be done upstream in the process and the reporting technology or analysis software will be none the wiser as to how the information was collected.

An embodiment's workflow is designed to handle modern data collection methods such as ultra-high definition (UHD) imagery and dense point clouds. This system is also developed to analyze the quality of data collected and enhance where appropriate. This enhancement can be in the form of image enhancement or model scaling for example. This workflow is not agnostic to legacy data. That is, the system has the ability to ingest and improve legacy data to allow for the delivery of more modern data products such as three-dimensional (3D) and artificial intelligence (AI) enhanced predictive analytics. This is in addition to the standard data deliverable products.

By removing the requirement to run multiple differing software tools and workflows for differing collection methodologies, an embodiment reduces the training time of new employees, decreases the turnaround time to the end customers, and allows one workflow for continuous development and improvements.

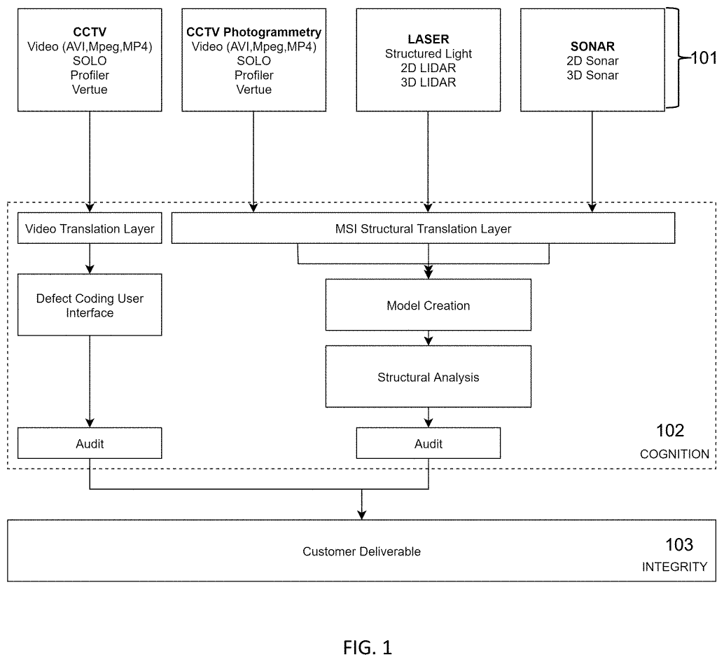

Referring to FIG. 1, a system architecture is illustrated where the aforementioned funnel of data processing activity is applied prior to an analysis or reporting tool handling the data. In the example of FIG. 1, payload data from multi-sensor inspection (MSI) payload sources 101, in this example the inspection payloads transported by the inspection platforms/robots and related sensors, are loaded into the system's translation layer 102 via a graphical user interface (GUI) or straight from a collection platform payload sources 101.

Metadata from the inspections, resident with payload data from payload sources 101, such as deployment, asset and inspection GUID's, are also loaded into a translation workflow performed by translation layer 102. This metadata will aid in directing the automatic process to transform the payload data from payload sources 101 into a common file format for consumption by analysis and reporting tools, in this example in layer 103, as further described herein.

Depending on the payload information, the correct conversion tool(s) will be invoked (also referred to herein as “selected”) within the translation layer 102 resulting in the data being outputted as a predetermined common data file format, e.g., a two part time and payload formatted data file as further described herein.

Once translated in an initial phase of translation layer 102, MSI data is run through one or more model creation tools of translation layer 102 where the translated information is then outputted to the reporting user vial analysis tools in layer 102, e.g., for analysis and signoff.

Within the creation stage of translation layer 102, the data is also automatically cross referenced with other information collected or provided (referred to herein as “reference” data or information), e.g., by a municipality, to increase the accuracy of the model of the underground infrastructure. For example, a known pipe ovality may be obtained as reference information. Other examples include but are not limited to manhole or shaft dimensions, material construction, known or previously identified defects, etc.

The translation layer is developed in such a way that it's functionality can easily be extended to absorb further types of payloads or different sensors within the payloads. Again, a goal of the translation layer 102 is to utilize respective metadata of the MSI payload sources 101 to choose a respective tool to extract MSI payload from the payload source 101 format (referred to herein as “first” or “second” format) and supply the payload data to a common data file structure along with reference or dictionary metadata.

Once the data has been translated and where applicable the models created into the common data file format, the analysis of the data is undertaken. In one example, there are two main types of analysis: visual defect coding of defects recorded by camera sensors of payload sources 101 and structural analysis of the two-dimensional (2D) or 3D models of the pipeline or other asset, created with the tools of translation layer 102. Once the analysis has been complete the data is audited and then delivered, e.g., via a cloud-based platform such as RedZone INTEGRITY 103.

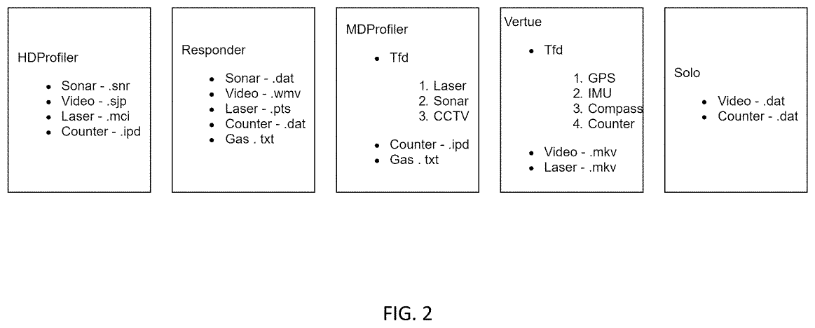

Referring to FIG. 2, an example of where this process may be utilized is the processing of MSI data from disparate payload sources (e.g., as shown in FIG. 1 at 101). For a system with various robotics utilized, e.g., five separate robots with four separate workflows such as HDPROFILER, MDPROFILER, RESPONDER, SOLO, and VERTUE robots available from RedZone Robotics, Inc, the example in FIG. 2 shows the differing file types for similar sensors for each of the platforms.

Within the transitional layer 102 of FIG. 1, the data is entered into the common data format (e.g., Time, Frame Data (tfd) file format). This common data file format is capable of storing any type of data as a payload (e.g., image data, sonar data, laser profiling data, point cloud data, etc.) as well as being capable of storing various data types within the same file, e.g., by extension of the payload and metadata hierarchy of the file. Included within the common data file format is also a dictionary payload that provides the metadata or meta information to describe the type of frame (payload), including for example manufacturer, serial number and type of information, for example, a common data file format may take the following form:

```
{
  17:{
  “FrameType”:“SONAR_RAY”,
  “DataType”:“RAY”,
  “Manufacturer”:“Marine Electronics”
  “Model”:“ME-2512e”,
  “MetaDataType”:“CBOR”
  “id”:“254”
  “type”:“Sonar”
}
```

As may be appreciated, the common data file format allows varying payloads and metadata to be formatted into a common data format that can be parsed by an analysis and reporting tool, such as provided in layer 103 of FIG. 1.

A next step (after the dictionary metadata has been entered) may include use of a model creation stage. For example, the “Frame Type” of the common data format will provide the processing tools access to payload type specific rules to begin the model creation stage using the type of payload indicated (e.g., image, video, laser profiling, point cloud, etc.) and perform every step in the process of processing inspection payload data that needs to be tracked for successful handing in a reporting workflow, e.g., creating a composite image featuring data of varying sensor payload types referenced to a 2D or 3D model and reference information, such as expected pipe ovality or shaft dimensions.

By way of example, referring to FIG. 2, a method is illustrated in which MSI data of differing sources and formats are consolidated into a common data file type, fused, and provided to a reporting workflow that determines a difference, e.g., sediment buildup within a pipe. As illustrated, MSI data is obtained at 301, e.g., from two or more sources such as a laser profiler and a sonar unit (noting that the two or more sources may be on the same or different inspection platform). The MSI metadata is used at 302 to select or activate appropriate translation tools for the respective MSI data. For example, metadata obtained from a laser profiler may indicate selection of a laser profiling translation tool that is capable of parsing the laser profiler's MSI data to identify payload and metadata in or associated with the MSI data file.

If more MSI data is to be handled, e.g., a third type of MSI data, the process may loop as indicated at 303 to select an additional tool. Otherwise, the process may continue to 304 in which the payload and metadata is applied to the common file format, e.g., MSI payload data is provided in a format such as a time, data format as indicated herein. This permits the translation layer to provide the common file format data files, as indicated at 305, for example to a workflow or directly to an output interface such as a reporting and analysis tool in layer 103 of FIG. 1.

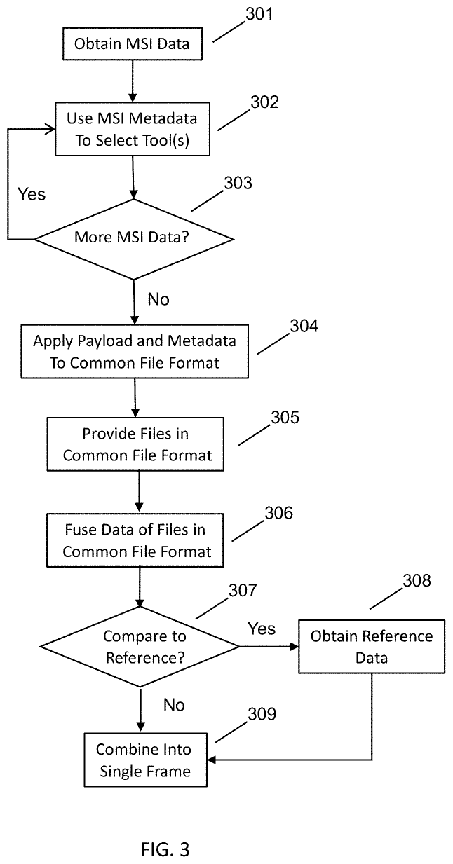

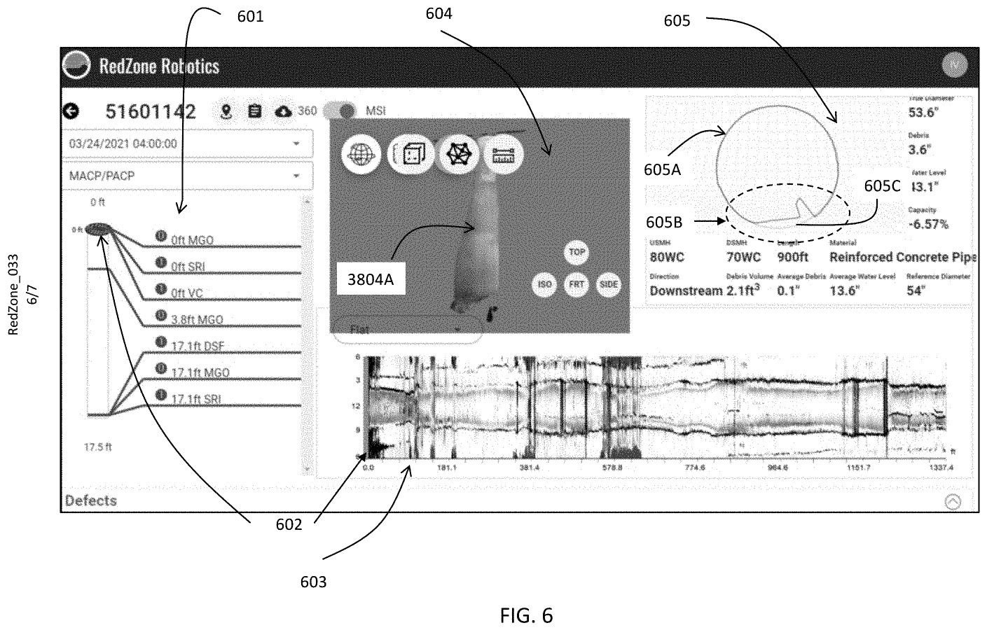

In the example of FIG. 3, data of the common format files may be fused at 306, e.g., matched in time and space with one another to prepare a single frame composite that includes data of multiple MSI data sources. In one example, described in further detail with FIG. 6, two MIS data types such as laser profiler and sonar unit data files may have their payloads combined into a fused frame of data, e.g., per the common file format.

If the data is to be compared to reference data or information, as determined at 307, reference data may be obtained as indicated at 308. For example, to compare a combined frame or file of laser profiler and sonar unit payload data, matched in time and space (location coordinates) to produce a 2D model of an inspected pipe profile, to a known pipe cross-section ovality, the reference cross-section ovality is obtained, noting that it may be sourced from prior inspection data (e.g., a fused frame collected at an earlier time, such as prior to cleaning the pipe).

The data contents (in this example, fused frame and reference data) may be combined into a single frame or composite display, as indicated at 309. Such as single frame or composite display may be provided via a reporting and analytics tool, such as indicated at 103 of FIG. 1.

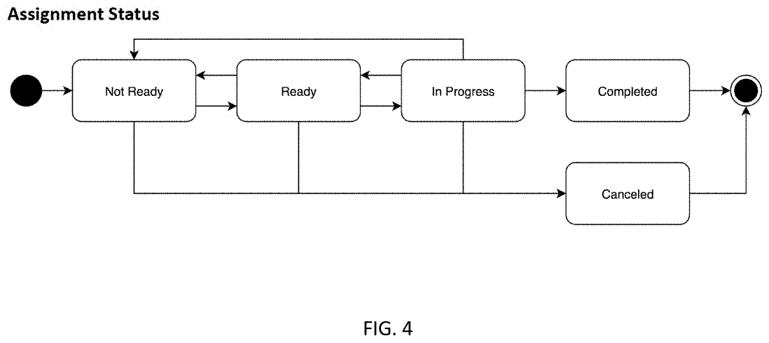

Referring to FIG. 4, in a workflow comprised of tasks, every task has a type, a set of parameters, a responsible party, and a result. An assignment represents a task that needs to be, or has been, performed. An assignment contains all the information required to perform the task and information associated with the performance of the task including: (1) Task type; (2) Status—The current state of task completion; (3) Resource(s) that will and/or did perform the task; (4) Targets that the task is to be performed on or with (e.g., infrastructure node for a data collection task, deployment or inspection for a quality assurance (QA) task, file for a data transfer task, etc.); (5) Attributes—Task-specific parameters or additional information such as work order numbers to link a task back to basecamp or a target location for a file copy; (6) Scheduled date/time for when it is expected to be started and expected to be done; (7) Actual date/time the task was started and completed; and (8) Result of the task when completed. This is different from the status in that all tasks have the same set of possible completion states but the end result of a completed task can vary by task type. Completion of a task does not mean the task was completed successfully. For instance, a data collection task can fail due to an inability to locate the target infrastructure asset and a QA task can have a failed result because the target did not meet required quality standards.

An example of assignment status is provided in FIG. 4. The assignment status may be: (a) Not Ready—Task is created but is missing information required to perform the task such as (a1) Assigned resources; (a2) Task target; (a3) Other task parameters; (b) Ready—Required parameters have been set and the task can be performed; (c) In Progress—Resource has claimed (taken ownership of) the assignment and work is in progress; (d) Completed—Work has been completed and a result has been set; (e) Canceled—The task has been canceled.

Assignment relationship types may include block, e.g., assignment 1 blocks assignment 2 until assignment 1 has a successful result, and parent/child, e.g., assignment 1 is the parent of assignment 2. The workflow models the sequence of tasks that must be performed, e.g., for the business operations or logic, such as that identified in FIG. 3 by way of example. The task planner is an object that contains the workflow and creates and updates tasks based on the state stored in the database. Each step in the workflow is responsible for determining what tasks need to be performed for that step, ensuring that the tasks have been created, and updating the state of tasks as needed. The task planner will either run in a constant loop or will be run in response to changes in the database.

Some tasks can be performed in parallel, and others performed sequentially. For instance, multiple data collection tasks for a given infrastructure asset can be active at the same time but the QA for the collected data cannot start until after the collection task is completed and the data is delivered to the central storage. Tasks are linked by relationships. An example relationship type is a blocking relationship. A task that must be completed before another task has a blocking relationship with the other task. All blocking tasks must be completed with a successful result before the blocked task can be started. This enables it to be determined if a task is available and if not, which tasks it is waiting on.

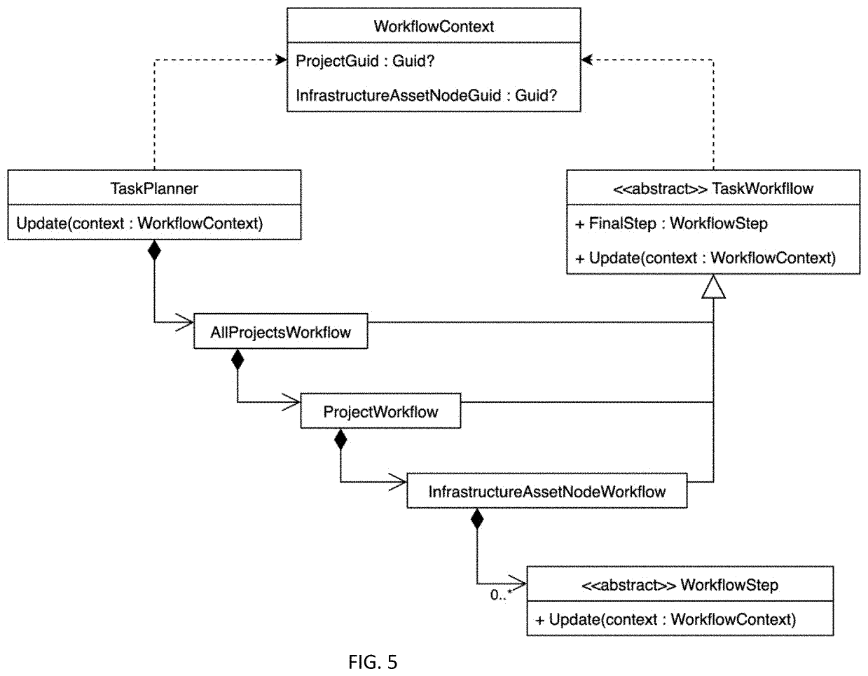

FIG. 5 illustrates an example overview of a hierarch used to organize workflows and related tasks or operations. At the top of the hierarchy is WorkflowContext. This object contains context information needed by the workflows and steps such as the project GUID, project requirements, and infrastructure asset GUID. Each level of workflow copies the input context and adds information needed by the next level down. TaskPlanner is the top level class that creates the workflows and handles updating them as needed. TaskWorkflow is an abstract base class for all workflow classes. AllProjectsWorkflow is a workflow that enumerates all the projects in the database. For each project, it gets the project requirements and calls Update on the ProjectWorkflow with the project GUID and requirements set in the context. ProjectWorkflow is a workflow calls Update on all workflows for a project. In one example, the InfrastructureAssetNodeWorkflow is supported, which will enumerate all infrastructure assets associated with the project and call Update with the asset GUID added to the context. InfrastructureAssetNodeWorkflow contains the steps defined for processing infrastructure assets. WorkflowStep is an abstract base class for all workflow step classes.

With respect to processing output, the resulting data from the processing step is then exported to the reporting analysis stage of the cloud platform, e.g., layer 103 of FIG. 1. The fact that everything is now exported to the analysis layer 103 in an identical format (common data format) allows for a single workflow that operates on multiple payload types, e.g., from a variety of payload sources 101. This in turn will ensure data consistency coupled with the increase speed of turnaround due to less steps in the process.

Referring to the example of FIG. 6, a composite display featuring fused data is provided. In the display, which may be a GUI having multiple panels relating data from multiple MSI data sources 1010, an example of fused data for a pipeline segment is provided. In the GUI, a pipe segment panel 601 includes a graphic view of a pipe network or segment thereof, including an indicator 602 facilitating identification of a location at which the inspection device has obtained the associated sensor data in the remaining panels. Here, the indicator 602 is at the very beginning of the pipe network panel 601 and the flat graph panel 603. This indicates the location of the inspection device relative to the pipe network physical location and the associated sensor data in the flat graph panel 603. The flat graph panel 603 illustrates a graph of sensor data, such as image, laser or LIDAR data regarding the geometry of the infrastructure, such as a pipe, projected onto a predetermined shape, such as a cylinder, and presented in a 2D graph via transformation (e.g., to 2D surface as illustrated).

The panels 604 and 605 illustrate 3D photographic imagery (composite image and laser point cloud image modeled manhole) 603A and laser and sonar composite image 2D geometry (cross section) of pipe segment 605A at the location of the indicator, respectively. With reference to the composite laser and sonar image 605A, an example of fused sensor output is provided in combination with reference data 605C.

As illustrated, the 2D profile of pipe at the indicator's 602 location is formed by fusing sensor data from laser profiler and sonar data from a sonar unit. As may be appreciated, in a water filled pipe or tunnel, the lower portion of the pipe or tunnel is obscured by water, rendering laser profiling data meaningless except to depict the water level. However, to obtain the 2D geometry of the pipe, it is necessary to fuse the laser profiling data (605A) for the upper portion of the pipe with the sonar profiling data for the lower portion of the pipe, indicated at 605B (sonar data). Therefore, the panel 605 comprises a composite image with two data types fused, e.g., per the processing described herein. Further, an embodiment allows for material and other calculations, e.g., deviation from true or predetermined geometry such as a perfect circle or prior inspection result, using a comparison between sensed data from composite image and the reference data 605C. These measured or calculated values may be presented to users via layer 103, such as a sediment build up report or quantitative value (e.g., for the length of the pipe segment). Such values may also be fed to an automated workflow step, e.g., trigger a sediment calculation workflow, trigger a pipe defect identification workflow, trigger an image or model output workflow, etc.

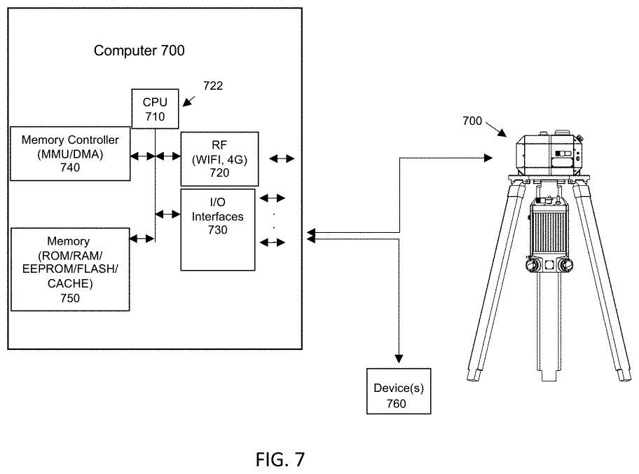

It will be readily understood that certain embodiments can be implemented using any of a wide variety of devices or combinations of devices. Referring to FIG. 7, an example device that may be used in implementing one or more embodiments includes a computing device (computer) 700, for example included in an inspection system 700 that provides MSI data, as a component thereof.

The computer 700 may execute program instructions or code configured to store and process sensor data (e.g., images from an imaging device or point cloud data from a sensor device, as described herein) and perform other functionality of the embodiments. Components of computer 700 may include, but are not limited to, a processing unit 710, which may take a variety of forms such as a central processing unit (CPU), a graphics processing unit (GPU), a combination of the foregoing, etc., a system memory controller 740 and memory 750, and a system bus 722 that couples various system components including the system memory 750 to the processing unit 710. The computer 700 may include or have access to a variety of non-transitory computer readable media. The system memory 750 may include non-transitory computer readable storage media in the form of volatile and/or nonvolatile memory devices such as read only memory (ROM) and/or random-access memory (RAM). By way of example, and not limitation, system memory 750 may also include an operating system, application programs, other program modules, and program data. For example, system memory 750 may include application programs such as image processing software. Data may be transmitted by wired or wireless communication, e.g., to or from an inspection robot 700 to another computing device, e.g., a remote device or system 760, such as a cloud platform that provides web-based applications and interfaces, such as GUI illustrated in FIG. 6.

A user can interface with (for example, enter commands and information) the computer 700 through input devices such as a touch screen, keypad, etc. A monitor or other type of display screen or device can also be connected to the system bus 722 via an interface, such as interface 730. The computer 700 may operate in a networked or distributed environment using logical connections to one or more other remote computers or databases. The logical connections may include a network, such local area network (LAN) or a wide area network (WAN) but may also include other networks/buses.

It should be noted that various functions described herein may be implemented using processor executable instructions stored on a non-transitory storage medium or device. A non-transitory storage device may be, for example, an electronic, electromagnetic, or semiconductor system, apparatus, or device, or any suitable combination of the foregoing. More specific examples of a non-transitory storage medium include the following: a portable computer diskette, a hard disk, a random-access memory (RAM), a read-only memory (ROM), an erasable programmable read-only memory (EPROM or Flash memory), a portable compact disc read-only memory (CD-ROM), a solid-state drive, or any suitable combination of the foregoing. In the context of this document “non-transitory” media includes all media except non-statutory signal media.

Program code embodied on a non-transitory storage medium may be transmitted using any appropriate medium, including but not limited to wireless, wireline, optical fiber cable, RF, etc., or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), a personal area network (PAN) or the connection may be made through other devices (for example, through the Internet using an Internet Service Provider), through wireless connections, or through a hard wire connection, such as over a USB or another power and data connection.

Example embodiments are described herein with reference to the figures, which illustrate various example embodiments. It will be understood that the actions and functionality may be implemented at least in part by program instructions. These program instructions may be provided to a processor of a device to produce a special purpose machine, such that the instructions, which execute via a processor of the device implement the functions/acts specified.

It is worth noting that while specific elements are used in the figures, and a particular illustration of elements has been set forth, these are non-limiting examples. In certain contexts, two or more elements may be combined, an element may be split into two or more elements, or certain elements may be re-ordered, re-organized, combined or omitted as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
obtaining, in a first data format, first multi-sensor inspection (MIS) data from a first sensor of one or more inspection platforms;
obtaining, in a second data format, second MSI data from a second sensor of the one or more inspection platforms;
identifying, using a processor, respective metadata associated with the first MSI data and the second MSI data;
using the respective metadata to select one or more tools for translating the first and second MSI data into a common file format;
the common file format comprising:
payload of a respective sensor derived from one or more of the first data format and the second data format; and
dictionary metadata comprising at least a part of the respective metadata associated with one or more of the first MSI data and the second MSI data;
applying the one or more tools to the first and second MSI data to obtain respective common data formatted files; and
providing, via a cloud computing device, access to the common data formatted files.

2. The method of claim 1, comprising fusing the common data formatted files to obtain a single frame of infrastructure data.

3. The method of claim 2, wherein the single frame of infrastructure data comprises one or more of a graphic and an image.

4. The method of claim 2, wherein fusing comprises obtaining payload data of a first of the common data formatted files, identifying a subset of the payload data as related to second payload data of a second of the common data formatted files, and combining the subset of the payload data with the second payload data in the single frame of infrastructure data.

5. The method of claim 4, wherein the identifying is based on the respective metadata.

6. The method of claim 1, wherein one or more of the first MSI data and the second MSI data comprises one or more of sonar data, video data, laser data, counter data, and gas data.

7. The method of claim 2, comprising obtaining reference data related to the single frame of infrastructure data.

8. The method of claim 7, comprising using the reference data and fused data of the common data formatted files to obtain comparison data.

9. The method of claim 8, wherein the comparison data indicates a deviation or defect with respect to the reference data.

10. The method of claim 8, wherein the reference data comprises one or more of a two-dimensional infrastructure model and a three-dimensional infrastructure model.

11. A device, comprising:
one or more processors; and
a non-transitory storage device operatively coupled to the one or more processors and comprising executable code, the executable code comprising:
code that obtains, in a first data format, first multi-sensor inspection (MIS) data from a first sensor of one or more inspection platforms;
code that obtains, in a second data format, second MSI data from a second sensor of the one or more inspection platforms;
code that identifies respective metadata associated with the first MSI data and the second MSI data;
code that uses the respective metadata to select one or more tools for translating the first and second MSI data into a common file format;
the common file format comprising:
payload of a respective sensor derived from one or more of the first data format and the second data format; and
dictionary metadata comprising at least a part of the respective metadata associated with one or more of the first MSI data and the second MSI data;
code that applies the one or more tools to the first and second MSI data to obtain respective common data formatted files; and
code that provides, via a cloud computing device, access to the common data formatted files.

12. The device of claim 11, wherein the executable code comprises code that fuses the common data formatted files to obtain a single frame of infrastructure data.

13. The device of claim 12, wherein the single frame of infrastructure data comprises one or more of a graphic and an image.

14. The device of claim 12, wherein the code that fuses comprises code that obtains payload data of a first of the common data formatted files, identifies a subset of the payload data as related to second payload data of a second of the common data formatted files, and combines the subset of the payload data with the second payload data in the single frame of infrastructure data.

15. The device of claim 14, wherein the code that identifies uses the respective metadata.

16. The device of claim 14, wherein one or more of the first MSI data and the second MSI data comprises one or more of sonar data, video data, laser data, counter data, and gas data.

17. The device of claim 12, wherein the executable code comprises code that obtains reference data related to the single frame of infrastructure data.

18. The device of claim 17, wherein the executable code comprises code that uses the reference data and fused data of the common data formatted files to obtain comparison data.

19. The device of claim 18, wherein the comparison data indicates a deviation or defect with respect to the reference data.

20. A computer program product, comprising:
a non-transitory storage medium that comprises code that when executed by a processor:
obtains, in a first data format, first multi-sensor inspection (MIS) data from a first sensor of one or more inspection platforms;
obtains, in a second data format, second MSI data from a second sensor of the one or more inspection platforms;
identifies respective metadata associated with the first MSI data and the second MSI data;
uses the respective metadata to select one or more tools for translating the first and second MSI data into a common file format;
the common file format comprising:
payload of a respective sensor derived from one or more of the first data format and the second data format; and
dictionary metadata comprising at least a part of the respective metadata associated with one or more of the first MSI data and the second MSI data;
applies the one or more tools to the first and second MSI data to obtain respective common data formatted files; and
provides, via a cloud computing device, access to the common data formatted files.
